(19) United States
(12) Patent Application Publication
(10) Pub. No.: US 2023/0410830 A1
(43) Pub. Date: Dec. 21, 2023

(54) AUDIO PURIFICATION METHOD, COMPUTER SYSTEM AND COMPUTER-READABLE MEDIUM

(71) Applicant: INNOPEAK TECHNOLOGY, INC., Palo Alto, CA (US)

(72) Inventors: Rongrong LIU, Palo Alto, CA (US); Yuan LIN, Palo Alto, CA (US)

(73) Assignee: INNOPEAK TECHNOLOGY, INC., Palo Alto, CA (US)

(21) Appl. No.: 18/460,232

(22) Filed: Sep. 1, 2023

Related U.S. Application Data
(63) Continuation of application No. PCT/US21/22823, filed on Mar. 17, 2021.

(51) Int. Cl. G10L 21/0232

(52) U.S. Cl. CPC G10L 21/0232; G10L 2021/02087

(57) ABSTRACT

This application is directed to audio purification. An audio purification method, a computer system and a non-transitory computer-readable medium are provided. The audio purification method includes: obtaining image data corresponding to a sequence of image frames that focus on lip movement of a person; obtaining audio data that is synchronous with the lip movement in the sequence of image frames; and modifying the audio data using the image data.

### CROSS REFERENCE TO RELATED APPLICATION

The present application is a continuation of International Patent Application No. PCT/US2021/022823, filed Mar. 17, 2021, which is herein incorporated by reference in its entirety.

### TECHNICAL FIELD

The present application generally relates to artificial intelligence, and more specifically to an audio purification method, a computer system and a non-transitory computer-readable medium for visually aided speech purification.

### BACKGROUND

Speech purification is a type of speech enhancement or speech denoising technique aiming to separate a voice of a target speaker from other noises (e.g., background noise and voices of the other people in a vicinity of the target speaker). It is often difficult to separate the target speaker's voice from the background noise without losing audio information of the target speaker. Particularly, separation of the target speaker's voice becomes increasingly difficult when multiple people arc talking at the same time, because human voices share similar audio features.

Deep learning techniques have been applied in speech purification and yielded significant improvements. For example, some existing techniques use visual information of the entire face of the target speaker to aid speech purification. These techniques introduce many unnecessary weights and computational steps that cannot be implemented efficiently in mobile devices that have limited capabilities. Alternatively, some other deep learning techniques use shallow convolution blocks that are suitable for mobile applications, and however, cannot achieve desirable speech purification results. It would be beneficial to develop systems and methods for implementing speech purification efficiently and accurately based on deep learning techniques.

### SUMMARY

The present application describes embodiments related to speech or audio purification. Various embodiments disclosed herein describe systems, devices, and methods that purify an individual speaker's voice by removing background noise, retain audio information that tends to be lost during speech purification, and isolate the individual speaker's voice when multiple people are speaking simultaneously. In some embodiments, the systems, devices, and methods disclosed herein make use of visual information movement of a target speaker, also known as “lip reading”) in addition to audio information. Specifically, a deep learning, model uses a residual neural network (e.g., ResNet) structure to capture a correlation between an audio input and a video input focusing on the speaker's lip movement and apply the correlation to enhance recognition of the speaker's voice while suppressing other sounds (e.g., background noise including other people's voices).

In one aspect, an audio purification method is implemented and includes: obtaining image data corresponding to a sequence of image frames that focus on lip movement of a person; obtaining audio data that is synchronous with the lip movement in the sequence of image frames and modifying the audio data using the image data, thereby reducing background noise in the audio data.

In accordance to another aspect of the present disclosure, a computer system includes one or more processors and memory storing instructions, which when executed by the one or more processors cause the processors to perform the audio purification method. The method includes: obtaining image data corresponding to a sequence of image frames that focus on lip movement of a person; obtaining audio data that is synchronous with the lip movement in the sequence of image frames and modifying the audio data using the image data, thereby reducing background noise in the audio data.

In accordance to another aspect of the present disclosure, a non-transitory computer readable storage medium stores instruction, which when executed by the one or more processing processors cause the processors to perform the audio purification method. The method includes: obtaining, image data corresponding to a sequence of image frames that focus on lip movement of a person; obtaining audio data that is synchronous with the lip movement in the sequence of image frames and modifying the audio data using the image data, thereby reducing background noise in the audio data.

### BRIEF DESCRIPTION OF DRAWINGS

For a better understanding of the various described implementations, reference should be made to the Detailed Description below, in conjunction with the following drawings in which like reference numerals refer to corresponding parts throughout the figures.

FIG. 1 is an example data processing environment having one or more servers communicatively coupled to one or more client devices, in accordance with some embodiments.

FIG. 2 is a block diagram illustrating a data processing system, in accordance with some embodiments.

FIG. 3 is an example data processing environment for training and applying a neural network based data processing model for processing visual and/or audio data, in accordance with some embodiments.

FIG. 4A is an example neural network applied to process content data in an NN-based data processing model, in accordance with some embodiments.

FIG. 4B is an example node 420 in the neural network, in accordance with some embodiments.

FIG. 5 is a flow diagram of an example audio purification process, in accordance with some embodiments.

FIGS. 6A-6E are five example user interfaces of different applications in which an audio purification process can be applied, in accordance with some embodiments.

FIGS. 7A-7D are a flow diagram of an example audio purification method, in accordance with some embodiments.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

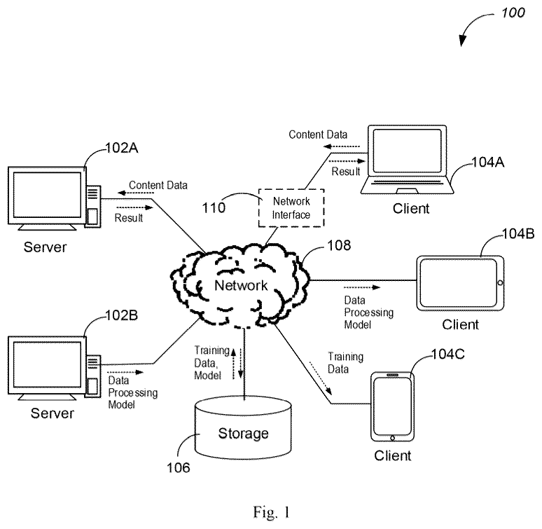

FIG. 1 is an example data processing environment 100 having one or more servers 102 communicatively coupled to one or more client devices 104, in accordance with some embodiments. The one or more client devices 104 may be, for example, a desktop computer 104A, a tablet computer 10413, a mobile phone 104C, or an intelligent, multi-sensing, network-connected home device (e.g., a camera). Each client device 104 can collect data or user inputs, execute user applications, and present outputs on its user interface. The collected data or user inputs can be processed locally at the client device 104 and/or remotely by the server(s) 102. The one or more servers 102 provides system data (e.g., boot files, operating system images, and user applications) to the client devices 104, and in some embodiments, processes the data and user inputs received from the client device(s) 104 when the user applications are executed on the client devices 104. In some embodiments, the data processing environment 100 further includes a storage 106 for storing data related to the servers 102, the client devices 104, and the applications executed on the client devices 104,

The one or more servers 102 can enable real-time data communication with the client devices 104 that are remote from each other or from the one or more servers 102. Further, in some embodiments, the one or more servers 102 can implement data processing tasks that cannot be or are preferably not completed locally by the client devices 104. For example, the client devices 104 include a game console that executes an interactive online gaming application. The game console receives a user instruction and sends it to a game server 102 with user data. The game server 102 generates a stream of video data based on the user instruction and user data and provides the stream of video data for display on the game console and other client devices that are engaged in the same game session with the game console. In another example, the client devices 104 include a networked surveillance camera and a mobile phone 104C. The networked surveillance camera collects video data and streams the video data to a surveillance camera server 102 in real time. While the video data is optionally pre-processed on the surveillance camera, the surveillance camera server 102 processes the video data to identify motion or audio events in the video data and shares information of these events with the mobile phone 104C, thereby allowing a user of the mobile phone 104 to monitor the events occurring near the networked surveillance camera in real time and remotely.

The one or more servers 102, one or more client devices 104, and storage 106 are communicatively coupled to each other via one or more communication networks 108, which are the medium used to provide communications links between these devices and computers connected together within the data processing environment 100. The one or more communication networks 108 may include connections, such as wires, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 108 may be established either directly (e.g., using 3G/4G connectivity to a wireless carrier), or through a network interface 110 (e.g., a router, a switch, a gateway, a hub, or an intelligent, dedicated whole-home control node), or through any combination thereof. As such, the one or more communication networks 108 can represent the Internet of a worldwide collection of networks and gateways that use the Transmission Control Protocol internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

Deep learning techniques are applied in the data processing environment 100 to process content data (e.g., video, image, audio, or textual data) obtained by an application executed at a client device 104 to identify information contained in the content data, match the content data with other data, categorize the content data, or synthesize related content data. In these deep learning techniques, data processing models are created based on one or more neural networks to process the content data. These data processing models are trained with training data before they are applied to process the content data. In some embodiments, both model training and data processing are implemented locally at each individual client device 104 (e.g., the client device 104C). The client device 104C obtains the training data from the one or more servers 102 or storage 106 and applies the training data to train the data processing models. Subsequently to model training, the client device 104C obtains the content data (e.g., captures video data via an internal camera) and processes the content data using the training data processing models locally. Alternatively, in some embodiments, both model training and data processing are implemented remotely at a server 102 (e.g., the server 102A) associated with a client device 104 (e.g. the client device 104A). The server 102A Obtains the training data from itself, another server 102 or the storage 106 and applies the training data to train the data processing models. The client device 104A obtains the content data, sends the content data to the server 102A (e.g., in an application) for data processing using the trained data processing models, receives data processing results from the server 102A, and presents the results on a user interface (e.g., associated with the application). The client device 104A itself implements no or little data processing on the content data prior to sending them to the server 102A. Additionally, in some embodiments, data processing is implemented locally at a client device 104 (e.g., the client device 104B), while model training is implemented remotely at a server 102 (e.g., the server 102B) associated with the client device 104B. The server 102B obtains the training data from itself, another server 102 or the storage 106 and applies the training data to train the data processing models. The trained data processing models are optionally stored in the server 102B or storage 106. The client device 104B imports the trained data processing models from the server 102B or storage 106, processes the content data using the data processing models, and generates data processing results to be presented on a user interface locally.

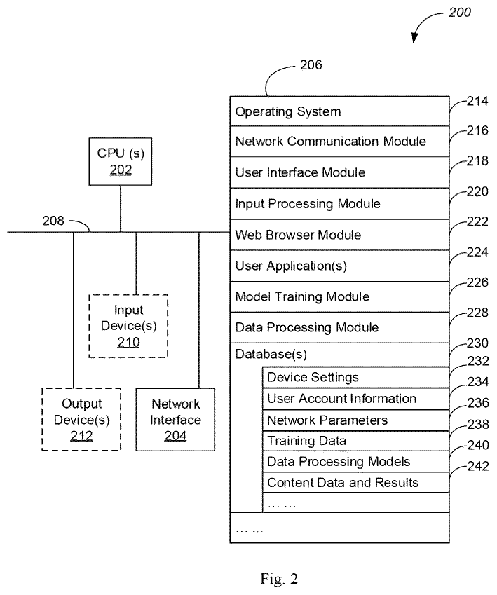

FIG. 2 is a block diagram illustrating a data processing system 200, in accordance with some embodiments. The data processing system 200 includes a server 102, a client device 104, a storage 106, or a combination thereof. The data processing system 200, typically, includes one or more processing units (CPUs) 202, one or more network interfaces 204, a memory 206, and one or more communication buses 208 for interconnecting these components (sometimes called a chipset). The data processing system 200 further includes one or more input devices 210 that facilitate user input, such as a keyboard, a mouse, a voice-command input unit or a microphone, a touch screen display, a touch-sensitive input pad, a gesture capturing camera, or other input buttons or controls. Furthermore, in some embodiments, the client device 104 of the data processing system 200 uses a microphone and a voice recognition process or a camera and a gesture recognition process to supplement or replace the keyboard. In some embodiments, the client device 104 includes one or more cameras, scanners, or photo sensor units for capturing images, for example, of graphic serial codes printed on the electronic devices. The data processing system 200 also includes one or more output devices 212 that enable presentation of user interfaces and display content, including one or more speakers and/or one or more visual displays. Optionally, the client device 104 includes a location detection device, such as a GPS (global positioning satellite) or other gees-location receiver, for determining the location of the client device 104.

The memory 206 includes a high-speed random access memory, such as DRAM, SRAM, DDR RAM, or other random access solid state memory devices; and, optionally, includes a non-volatile memory, such as one or more magnetic disk storage devices, one or more optical disk storage devices, one or more flash memory devices, or one or more other non-volatile solid state storage devices. The memory 206, optionally, includes one or more storage devices remotely located from one or more processing units 202. The memory 206 or alternatively the non-volatile memory within the memory 206, includes a non-transitory computer readable storage medium. In some embodiments, the memory 206, or the non-transitory computer readable storage medium of memory 206, stores the following programs, modules, and data structures, or a subset or superset thereof:
an operating system 214 including procedures for handling various basic system services and for performing hardware dependent tasks;
a network communication module 216 configured for connecting each server 102 or client device 104 to other devices (e.g., the server 102, the client device 104, or the storage 106) via one or more (wired or wireless) network interfaces 204 and one or more communication networks 108, such as the Internet, other wide area networks, local area networks, metropolitan area networks, and so on;
a user interface module 218 configured for enabling presentation of information (e.g., a graphical user interface for application(s) 224, widgets, websites and web pages thereof, and/or (games, audio end/or video content, text, etc.) at each client device 104 via one or more output devices 212 (e.g., displays, speakers, etc.);
an input processing module 220 configured for detecting one or more user inputs or interactions from one of the one or more input devices 210 and interpreting the detected input or interaction;
a web browser module 222 configured for navigating, requesting (e.g., via HTTP), and displaying websites and web pages thereof, including a web interface for logging into a user account associated with a client device 104 or another electronic device, controlling the client or electronic device if associated with the user account, and editing and reviewing settings and data that are associated with the user account;
one or more user applications 224 configured for execution by the data processing system 200 (e.g., games, social network applications, smart home applications, and/or other web or non-web based applications for controlling another electronic device and reviewing data captured by such devices);
a model training module 226 configured for receiving training data and establishing a data processing model for processing content data (e.g., video, image, audio, or textual data) to be collected or obtained by a client device 104;
a data processing module 228 configured for processing content data using data processing models 240, thereby identifying information contained in the content data, matching the content data with other data, categorizing the content data, or synthesizing related content data, where in some embodiments, the data processing module 228 is associated with one of the user applications 224 to process the content data in response to a user instruction received from the user application 224;
one or more databases 230 for storing at least data including one or more of;
   device settings 232 including common device settings (e.g., service tier, device model, storage capacity, processing capabilities, communication capabilities, etc.) of the one or more servers 102 or client devices 104;
   user account information 234 for the one or more user applications 224, e.g., user names, security questions, account history data, user preferences, and predefined account settings;
   network parameters 236 for the one or more communication networks 108, e.g., IP address, subset mask, default gateway, DNS server and host name;
   training data 238 for training one or more data processing models 240;
   data processing model(s) 240 configured for processing content data (e.g., video, image, audio, or textual data) using deep learning techniques; and
   content data and results 242 that are obtained by and outputted to the client deice 104 of the data processing system 200, respectively, where the content data is processed by the data processing models 240 locally at the client device 104 or remotely at the server 102 to provide the associated results 242 to be presented on client device 104.

Optionally, the one or more databases 230 are stored in one of the server 102, the client device 104, and the storage 106 of the data processing system 200. Optionally, the one or more databases 230 are distributed in more than one of the server 102, the client device 104, and the storage 106 of the data processing system 200. In some embodiments, more than one copy of the above data is stored at distinct devices, e.g., two copies of the data processing models 240 are stored at the server 102 and the storage 106, respectively.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise rearranged in various embodiments. In some embodiments, the memory 206, optionally, stores a subset of the modules and data structures identified above. Furthermore, the memory 206, optionally, stores additional modules and data structures not described above.

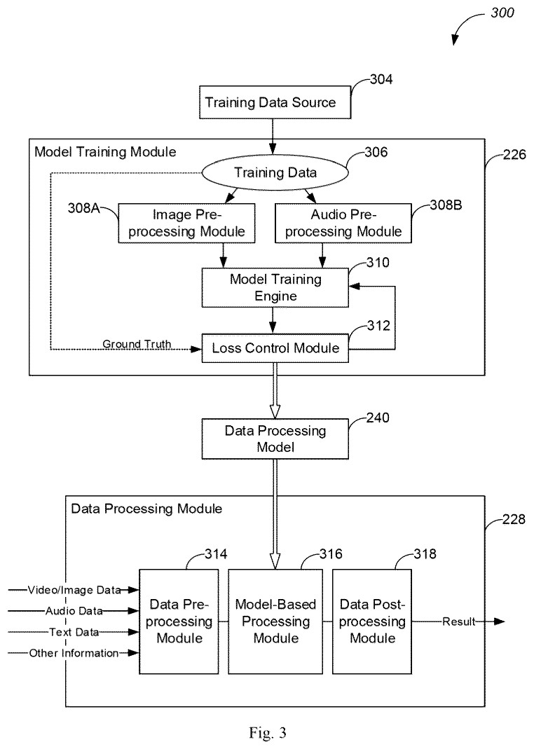

FIG. 3 is another example data processing system 300 for training and applying a neural network based (NN-based) data processing model 240 for processing content data (e.g., video, image, audio, or textual data), in accordance with some embodiments. The data processing system 300 includes: a model training module 226 for establishing the data processing model 240 and a data processing module 228 for processing the content data using the data processing model 240, in some embodiments, both of the model training module 226 and the data processing module 228 are located on a client device 104 of the data processing system 300, while a training data source 304 distinct form the client device 104 provides training, data 306 to the client device 104. The training data source 304 is optionally a server 102 or a storage 106. Alternatively, in some embodiments, both of the model training module 226 and the data processing module 228 are located on a server 102 of the data processing system 300. The training data source 304 providing the training data 306 is optionally the server 102 itself, another server 102, or the storage 106. Additionally, in some embodiments, the model training module 226 and the data processing module 228 are separately located on a server 102 and a client device 104, and the server 102 provides the trained data processing model 240 to the client device 104.

The model training module 226 includes one or more data pre-processing modules 318, a model training engine 310, and a loss control module 312. The data processing model 240 is trained according to a type of the content data to be processed. The training data 306 is consistent with the type of the content data, so is a data pre-processing module 308 applied to process the training data 306 consistent with the type of the content data. For example, an image pre-processing module 308A is configured to process image training data 306 to a predefined image format, e.g., extract a region of interest (ROI) in each training image, and crop each training image to a predefined image size. Alternatively, an audio pre-processing module 30813 is configured to process audio training data 306 to a predefined audio format, e.g., converting each training sequence to a frequency domain using a Fourier transform. The model training engine 310 receives pre-processed training data provided by the data pre-processing modules 308, further processes the pre-processed training data using an existing data processing model 240, and generates an output from each training data item. During this course, the loss control module 312 can monitor a loss function comparing the output associated with the respective training data item and a ground truth of the respective training data item. The model training engine 310 modifies the data processing model 240 to reduce the loss function, until the loss function satisfies a loss criteria (e.g., a comparison result of the loss function is minimized or reduced below a loss threshold). The modified data processing model 240 is provided to the data processing module 228 to process the content data.

In some embodiments, the model training module 226 offers supervised learning in which the training data is entirely labelled and includes a desired output for each training data item (also called the ground truth in some situations). Conversely, in some embodiments, the model training module 226 offers unsupervised learning in which the training data are not labelled. The model training module 226 is configured to identify previously undetected patterns in the training data without pre-existing labels and with no or little human supervision. Additionally, in some embodiments, the model training module 226 offers partially supervised learning in which the training data are partially labelled.

The data processing module 228 includes a data pre-processing modules 314, a model-based processing module 316, and a data post-processing module 318. The data pre-processing modules 314 pre-processes the content data based on the type of the content data. Functions of the data pre-processing modules 314 are consistent with those of the pre-processing modules 308 and covert the content data to a predefined content format that is acceptable by inputs of the model-based processing module 316. Examples of the content data include one or more of: video, image, audio, textual, and other types of data. For example, each image is pre-processed to extract an ROI or cropped to a predefined image size, and an audio clip is pre-processed to convert to a frequency domain using a Fourier transform. In some situations, the content data includes two or more types, e.g., video data and textual data. The model-based processing module 316 applies the trained data processing model 240 provided by the model training module 226 to process the pre-processed content data. The model-based processing module 316 can also monitor an error indicator to determine whether the content data has been properly processed in the data processing model 240. In some embodiments, the processed content data is further processed by the data post-processing module 318 to present the processed content data. In a preferred format or to provide other related information that can be derived from the processed content data.

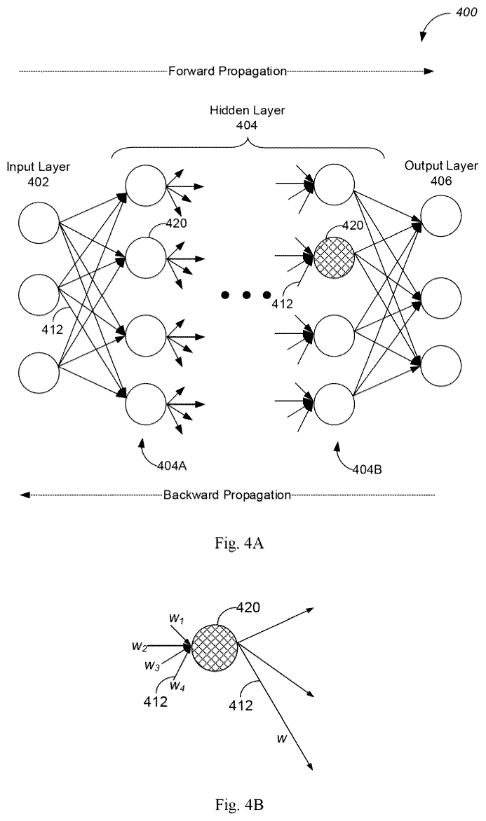

FIG. 4A is an example neural network (NN) 400 applied to process content data m an NN-based data processing model 240, in accordance with some embodiments, and FIG. 4B is an example node 420 in the neural network (NN) 400, in accordance with some embodiments. The data processing model 240 is established based on the neural network 400. A corresponding model-based processing module 316 applies the data processing model 240 including the neural network 400 to process content data that has been converted to a predefined content format. The neural network 100 includes a collection of nodes 420 that are connected by links 412. Each node 420 receives one or more node inputs and applies a propagation function to generate a node output from the one or more node inputs. As the node output is provided via one or more links 412 to one or more other nodes 420, a weight w associated with each link 412 is applied to the node output. Likewise, the one or more node inputs are combined based on corresponding weights w₁, w₂, w₃, and w₄ according to the propagation function. In an example, the propagation function is a product of a non-linear activation function and a linear weighted combination of the one or more node inputs.

The collection of nodes 420 is organized into one or more layers in the neural network 400. Optionally, the one or more layers includes a single layer acting as both an input layer and an output layer. Optionally, the one or more layers includes an input layer 402 for receiving inputs, an output layer 406 for providing outputs, and zero or more hidden layers 404 (e.g., 404A and 404B) between the input layers 402 and the output layers 406. A deep neural network has more than one hidden layers 404 between the input layers 402 and the output layers 406. In the neural network 400, each layer is only connected with its immediately preceding layer and/or immediately following layer. In some embodiments, a layer 402 or 404B is a fully connected layer because each node 420 in the layer 402 or 404B is connected to every node 420 in its immediately following layer. In some embodiments, one of the one or more hidden layers 404 includes two or more nodes that are connected to the same node in its immediately following layer for down sampling or pooling the nodes 420 between these two layers. Particularly, max pooling uses a maximum value of the two or more nodes in the layer 404B for generating the node of the immediately following layer 406 connected to the two or more nodes.

In some embodiments, a convolutional neural network (CNN) is applied in a data processing model 240 to process content data (particularly, video data and image data). The CNN employs convolution operations and belongs to a class of deep neural networks 400, i.e., a feed-forward neural network that only moves data forward from the input layer 402 through the hidden layers to the output layer 406. The one or more hidden layers of the CNN are convolutional layers convolving with a multiplication or dot product. Each node in a convolutional layer receives inputs from a receptive area associated with a previous layer (e.g., five nodes), and the receptive area is smaller than the entire previous layer and may vary based on a location of the convolution layer in the convolutional neural network. The video data or image data is pre-processed to a predefined vide of image format corresponding to the inputs of the CNN. The pre-processed video or image data is abstracted by each layer of the CNN to a respective feature map. By these means, video and image data can be processed by the CNN for video and image recognition, classification, analysis, imprinting, or synthesis.

Alternatively and additionally, in some embodiments, a recurrent neural network (RNN) is applied in the data processing model 240 to process content data (particularly, textual and audio data). Nodes in successive layers of the RNN follow a temporal sequence, such that the RNN exhibits a temporal dynamic behavior. In an example, each node 420 of the RNN has a time-varying real-valued activation. Examples of the RNN include, but are not limited to, a long short-term memory (LSTM) network, a fully recurrent network, an Elman network, a Jordan network, a Hopfield network, a bidirectional associative memory (BAM network), an echo state network, an independently RNN (IndRNN), a recursive neural network, and a neural history compressor. In some embodiments, the RNN can be used for handwriting or speech recognition. It is noted that in some embodiments, two or more types of content data are processed by the data processing module 228, and two or more types of neural networks (e.g., both CNN and RNN) are applied to process the content data jointly.

The training process is a process for calibrating all of the weights w₁ for each layer of the learning model using a training data set which is provided. in the input layer 402. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured, and the weights are adjusted accordingly to decrease the error. The activation function is optionally linear, rectified linear unit, sigmoid, hyperbolic tangent, or of other types. In some embodiments, a network bias term b is added to the sum of the weighted outputs from the previous layer before the activation function is applied. The network bias b provides a perturbation that helps the NN 400 to avoid over fitting of the training data. The result of the training includes the network bias parameter b for each layer.

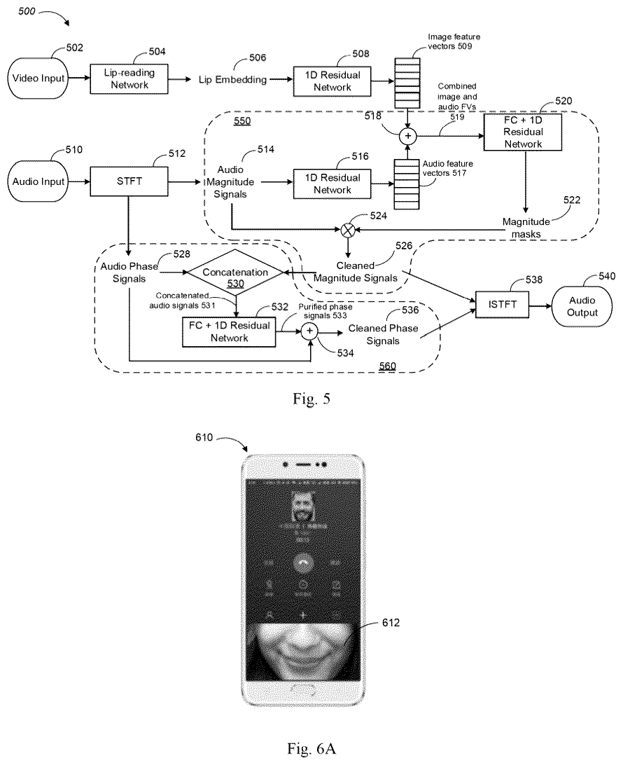

FIG. 5 is a flow diagram of an example audio purification process 500, in accordance with some embodiments. In some embodiments, the audio purification process 500 is also referred to as a speech de-noising process. At a high level, the audio purification process 500 involves obtaining audio data (e.g., audio input 510) and modifying the audio data using image data (e.g., video data) that is synchronous with the audio data. The image data corresponds to a sequence of image frames that focus on lip movement of a target speaker. The process 500 makes use of the visual information (e.g., the lip movement data), to learn deep features and correlations with the speech input, which are then used further to enhance the target voice and suppress all other accompanying sounds (i.e., background noise including other persons' voice). The process 500 generates output audio data (e.g., the output audio 540) that has reduced background noise compared to the audio input 510). The audio purification process 500 is speaker-independent and applicable to voice-related applications.

In some embodiments, the audio purification process 500 includes a video input 502. The video input 502 includes a temporal sequence of image frames, such as a sequence of image data (e.g., ROB images, black and white images), which are captured by a camera. Optionally, the video input 502 is obtained and purified locally by an electronic device 104 (e.g. a mobile phone) that includes the camera. Optionally, the video input 502 is transferred to and purified by another electronic device 104 (e.g., which receives video data via a video conferencing application). In some embodiments, the image frames of the video input 502 include a person's face (e.g., a target speaker's face). In some embodiments, the video input 502 is a sequence of image frames that focus on the lips of the person (e.g., lip movement of the person). Further, in some embodiments, the video input 502 corresponds to a sequence of raw image frames concerning the person, and the sequence of raw image frames are scaled and/or cropped to the video input 502 that focuses on the lip movement of the person.

In some embodiments, the video input 502 is processed by resampling the acquired video from an acquisition rate (e.g., 30 frames per second (fps)) to a resampled rate (e.g., 25 fps), and then dividing the resampled video into video segments. For example, the video segments can include fixed segments with a known number of frames per segment e.g., 60 frames per segment, or 240 milliseconds per frame), with or without overlapping frames between consecutive segments (e.g., with 10 frames overlap between consecutive segments).

With continued reference to FIG. 5, the video input 502 is used as input for a lip-reading neural network 504 in accordance with some embodiments. In some embodiments, the lip-reading neural network 504 includes a three-dimensional residual neural network (3D ResNet) that includes multiple residual blocks having residual connections between inputs and outputs of the residual blocks. Each residual block has interleaved layers of convolutions (e.g. spatial or spatiotemporal convolutions), non-linear activation functions (e.g., rectified linear (ReLu) activation function, Parametric Rectified Linear Unit (PReLU) activation function), and max-pooling layers, Further, in some embodiments, these residual blocks are followed by a bidirectional LSTM layer and one or more fully connected layers. Alternatively, in some embodiments, the bidirectional LSTM layer is only used in the training phase and is removed during actual implementation of the lip-reading network 504, and the residual blocks are followed by the one or more fully connected layers without the LSTM layer in the inference phase.

In some embodiments, the lip-reading neural network 504 is a pre-trained network that has been prior trained using a huge lip-reading dataset which contains lip image sequences from different angles, which are mapped to known sets of words/vocabularies. The lip-reading network 504 is used for visual feature extraction during an inference phase. The lip-reading neural network 504 extracts features from images of the video input 502 and generates lip embedding feature vectors in a lip embedding space 506. The lip embedding feature vectors contain lip information (e.g. information of the movements of lips, a mouth, and/or a tongue) that is necessary for deciphering speech. The lip embedding feature vectors are then processed using a ID image-related residual neural network 508 to generate one or more image feature vectors 509. In an example, each of the image feature vectors 509 includes 1024 or 512 elements.

The audio purification process 500 also includes obtaining an audio input 510. In some embodiments, the audio input 510 includes audio data that is synchronous in time with the video input 502. The audio input 510 includes a voice of a person as the person is speaking. In some situations, the audio input 510 may be acquired in a crowded environment and contains the voice of the target speaker as well as the background noise including, but not limited to, sound from other people talking while the target speaker is speaking, sound from moving vehicles or crying babies, and music playing in the background.

In some embodiments, a short-time Fourier transform (STFT) 512 is applied to the audio input 510. The STFT 512 converts the audio input 510 from a time domain signal to a frequency domain signal. The STFT 512 is a type of Fourier transform that is used for determining sinusoidal frequency and phase content of local sections of an audio signal as it changes over time. In some embodiments, the STFT 512 is a particularly suitable method for use in speech processing because speech is a temporal signal having properties that change with time. In some embodiments, a Hann window (or a Hann filter) is used to limit the speech signal within a short period of time. The output of the SIFT 512 includes two representations, namely, a real-imaginary representation or a magnitude-phase representation. The magnitude-phase representation is illustrated in FIG. 5. In this example, the STFT 512 includes a spectrogram that includes audio magnitude signals 514 and audio phase signals 528. Stated another way, the STFT 512 splits the audio input 510 into the audio magnitude signals 514 and audio phase signals 528 in a frequency domain.

In some embodiments, the audio input 510 is a pre-processed audio sequence in which raw audio signals are resampled to a given frequency (e.g., 16 kHz) and a Hann window is set to a given window size (e.g., 640 samples, or 40 milliseconds, which corresponds to the length of a single video frame in the video input 502). In some embodiments, the spectrogram that is obtained from the STFT 512 is sliced into pieces each having a length of 2400 milliseconds, corresponding, to the length of 60 video frames, to match the length of a video segment. It should be apparent to one of ordinary skill in the art that the parameters provided in this example (e.g., the window size, the video frame rate, the audio sampling rate, etc.) are merely illustrative for explaining the system input, and can he adjusted based on different application needs. In some embodiments, a filter (e.g., a bandpass filter) can also be applied to remove sound having known frequencies and/or patterns, such as background sound emitted by objects such as vehicles, babies crying, etc.

In some embodiments, the audio magnitude signals 514 are processed using a 1D audio-related residual neural network 516 to generate one or more audio feature vectors 517. In an example, each audio feature vectors 517 has 1024 or 512 elements. The one or more image feature vectors 509 are combined (518) with the one or more audio feature vectors 517 (e.g., via a concatenation or summation process 518) to produce combined image and audio feature vectors 519, which are further processed using a fully-connected (FC), 1D residual neural network 520 to generate magnitude masks 522. In some embodiments, the residual neural network 520 is a fully-connected network that includes one or more residual blocks. The residual blocks include multiple spatial convolution or spatiotemporal convolution layers, along with the non-linear activation layers (e.g., ReLU), and max-pooling layers. Each layer is fed into the next layer while another residual connection exists between the input and the output. The residual connection alleviates a degradation problem where shallow networks outperform deep networks by avoiding a vanishing gradient associated with the deep networks. In the example of FIG. 5, the residual blocks of the residual neural network 520 can take the context information of both the video input 502 and audio input 510 into consideration.

The magnitude masks 522 include audio filters based on the combined image and audio feature vectors 519. When the magnitude masks 522 are combined (524) with the audio magnitude signals 514, the audio filters process the audio magnitude signals 514 to generate cleaned magnitude signals 526. From a different perspective, a magnitude sub-network 550 is applied to derive the cleaned magnitude signals 526 from the audio magnitude signals 514. This magnitude sub-network 530 includes multiple residual blocks (e.g., those in the networks 516 and 520), fully connection layers, pooling layers and up-sampling layers. The magnitude sub-network 550 integrates the visual features in the image feature vectors 509 created by the lip-reading network 504 and the noisy audio magnitude signals 514 of the audio input 510, and maps a result onto a dimension of a magnitude spectrogram to generate magnitude masks 522 corresponding to the frequency domain. The magnitude masks 522 are applied to the audio magnitude signals 514 to produce the cleaned magnitude signals 526.

The audio phase signals 528 are concatenated (530) with the cleaned magnitude signals 526 to produce concatenated audio signals 531. The concatenated audio signals 531 is processed using a phase-related residual network 532, such as a fully connected (FC), 1D residual neural network 532, to generate purified phase signals 533. The purified phase signals 533 are combined (534) (e.g., summed) with the audio phase signals 528 to produce cleaned phase signals 536.

In some embodiments, the residual neural network 532 is a phase-related neural network. In some embodiments, the residual neural network 532 is also part of a phase sub-network 560 applied to derive the cleaned phase signals 536 from the audio phase signals 528. A phase includes characteristics that are different from those of a magnitude, and a phase sub-network 560 is designed to particularly enhance the phase of the audio input 510. The magnitude and phase spectrograms are correlated, and the phase sub-network 560 is conditioned on the audio phase signals 528 and the cleaned magnitude signals 526 generated by the magnitude sub-network 550. In the phase sub-network 560, the signals 526 and 528 are concatenated and fed into a series of residual blocks and linear layers, thereby mapping the signals 526 and 528 onto a dimension of a phase spectrogram prior to being added to the audio phase signals 528 (which include background noise). In some embodiments, the cleaned phase signals 536 are normalized with an L2 norm in a final denoised phase.

In some embodiments, multilayer perceptions (MLPs) consisting of several hilly connection layers are placed in the end of neural networks used in the magnitude sub-network 550 and the phase sub-network 560. For example, the MLPs are applied after the residual neural network 520 or residual neural network 532. The MLPs take the input from the residual blocks in the neural network 520 and generate the audio magnitude masks 522 that are related with the image sequence. The output of the residual neural network 520 has the same dimensions as those of the audio signals, such that de-noised audio signals can he obtained using element-wise multiplication of the audio magnitude signals 514 and the magnitude masks 522.

After the cleaned magnitude signals 526 and the phase signals 536 are obtained, the modified audio data (e.g., audio output 540) is recovered from them is an inverse short time Fourier transform (ISTFT) 538. The ISTFT 538 is the inverse operation of the STFT 512. The ISTFT operation 538 transforms the cleaned magnitude signals 526 and the phase signals 536 in which noise has been removed in a complex space to an audio output 540 in a temporal domain. The audio output 540 focuses on the speaker's voice, while other background noise (e.g., other speakers' voices) is suppressed.

In some embodiments, the magnitude sub-network 550 is trained by minimizing a magnitude loss between a ground truth magnitude spectrogram (M_{groundtruth}) and a predicted magnitude spectrogram (M_{predicted}). In some embodiments, the phase sub-network 560 is trained by maximizing a cosine similarity between a ground truth phase spectrogram (ϕ_{groundtruth}) and a predicted one scaled by the magnitudes. In some embodiments, the overall loss, L, is a combination of the magnitude loss and a phase loss, with a tunable hyperparameter λ as follows:

$$L = {‖ {M}_{groundtruth} - {M}_{predicted} ‖}_{1} - λ \frac{1}{TF} {\sum }_{t , f} {M}_{t , f , groundtruth} < {φ}_{t , f , predicted} - {φ}_{t , f , groundtruth} > \qquad ( 1 )$$

Inclusion of image frames that focus on lip movement (e.g., lip-reading component) of a person has several advantages. First, the lip-reading component can significantly improve performance of speech separation by enlarging a signal-to-distortion ratio and lowering a word error rate when a speech recognition program is implemented on the audio output 540. Second, residual structures can extract features from the audio input 510 and video input 502 effectively, thereby improving computation efficiency and overall performance of speech purification. Third, the audio purification process 500 is fully convolutional in the inference phase. Furthermore, in some embodiments, the audio purification process 500 does not include any LSTM layer, thereby resulting in a faster inference speed.

Speech purification and separation can be used in many speech-related applications, such as live broadcasting, video or voice chats (e.g., using video/voice chat applications, such as WeChat™, WhatsApp™, and FaceTime™), video or voice messaging video or audio conferencing (e.g., using conferencing applications, such as Skype™, Webex™, and Zoom™), karaoke and other singalong applications, speech dictation, language translation (e.g., using a dictionary application, such as Youdao Dictionary), voiceprint, voice assistant applications (e.g. Siri™, Cortana™, etc.), video blogging, and any other applications that include speech recognition of voice inputs (e.g., Xunfei/Sogou voice input method).

In some embodiments, the audio purification process 500 is implemented locally in an electronic device 104 (e.g., a mobile phone) that collects the video input 502 and audio input 510 using its own input devices (e.g., a camera and a speaker). In some embodiments, the audio purification process 510 is implemented locally in an electronic device 104 (e.g. a mobile phone) that receives the video input 502 and audio input 510 from a distinct electronic device 104. In some embodiments, both training and inference of the audio purification process 500 are implemented at the electronic device 104. In some embodiments, training of the neural networks used in the audio purification process 500 are implemented remotely at a server 102, and a data processing model (including these neural networks) is provided to the electronic device 104 to implement the inference stages locally.

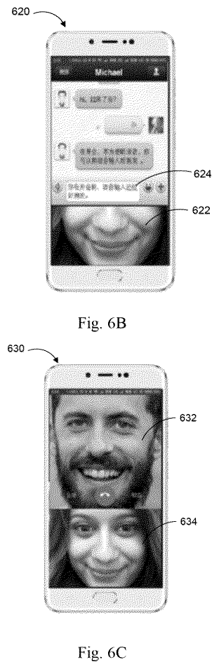

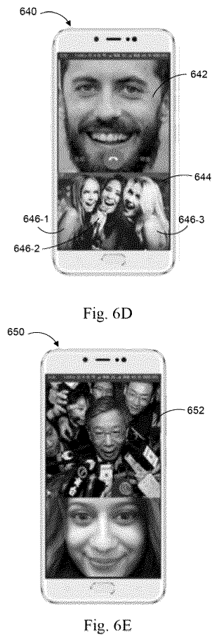

FIGS. 6A-6E are five example user interfaces of different applications in which an audio purification process can be applied, in accordance with some embodiments. Referring to FIG. 6A, an exemplary phone call interface 610 is displayed on a mobile phone 104C that includes a camera (e.g., an RGB camera or an RGB-D camera). In this example, the interface 610 includes a live image 612 of the user (e.g., the person making the call), to help the user to ensure that the user's face can be monitored by the camera. Referring to FIG. 6B, an exemplary speech recognition interface 620 is displayed on a mobile phone 104C that includes a camera (e.g., an ROB camera or an RGB-D camera). In this example. the mobile phone receives voice input from the user via one or more microphones of the mobile phone and receives video input that includes lip movement of the user via the camera. The electronic device processes the voice and video input of the user using the audio purification process 500 that is described in FIG. 5, and outputs a text transcription 624 of the voice input in the speech recognition interface 620.

Referring to FIG. 6C, an exemplary video chat interface 630 is displayed on a mobile phone 104C that includes a camera (e.g., an ROB camera or an RGB-D camera) In this example, the interface 630 illustrates images 632 and 634 (e.g., live video) of the participants of a video call, in some embodiments, the audio purification process 500 can purify the voices of the participants of the call as long as the participants' faces (e.g., lips) can be monitored by the respective cameras of the devices that are equipped with the chat interface 630.

Referring to FIG. 6D, an exemplary one-to-many (or many-to-one) video chat interface 640 is displayed. A video call includes one participant on one end and multiple participants on the other end. In the example of the FIG. 6D, the interface 640 illustrates an image 642 (e.g., a video stream) of one participant on one end and an image (e.g., a video stream) that includes three participants 646-1, 646-2, and 646-3 on the other end. In some embodiments, any participant can select anyone in the images 642 and 644 to enable or disable the voice of the selected person. In some embodiments, participants whose voices are enabled will be represented in one manner (e.g., their faces will be shown in full color) whereas participants whose voices are disabled will be represented in another manner (e.g., their faces will be shown in grayscale). In some embodiments, the application program corresponding to the interface 640 also includes facial recognition functions. For example, the face of a speaker re-enters the field-of-view of the camera after having exited the field-of-view of the camera previously, the application program can automatically recognize that face and enable or disable the voice of the speaker. In some embodiments, a user can adjust the sound volume of each person independently. This is particularly useful in a video conference scenario, whereby a participant sitting further away from the camera tends to have a lower sound volume. In this case, the sound volume of the participant can be amplified either manually or automatically.

In an example, a use selects one of the participants as a target person on the user interface 640. An electronic device obtains a sequence of image frames and identifies in the sequence of image frames one or more participants including the selected participant. The sequence of image frames are optionally modified to further focus on the lip movement of the person. The image frames (modified or not) optionally include other participants' images. The audio data obtained with the original image frames is modified to reduce voice signals of a subset of the one or more participants other than the selected participant. In some embodiments, the selected participant is displayed in full color, while the subset of participants that are not selected are displayed in gray color.

Referring to FIG. 6E, an exemplary interface 650 is displayed in an interview application program, in which the person being interviewed is depicted in image 652 (e.g., video stream 652). The interview application program records an audio stream of the interview with a video stream that includes the face (e.g., lips) of the interviewee. The interview application program implements the audio purification process 500 and outputs processed audio that contains only the voice of the interviewee while suppressing (or eliminating) other background sounds that were present in the audio stream of the interview.

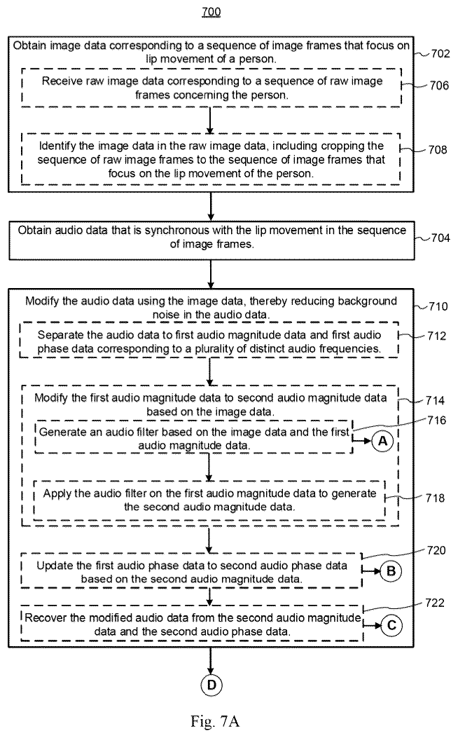

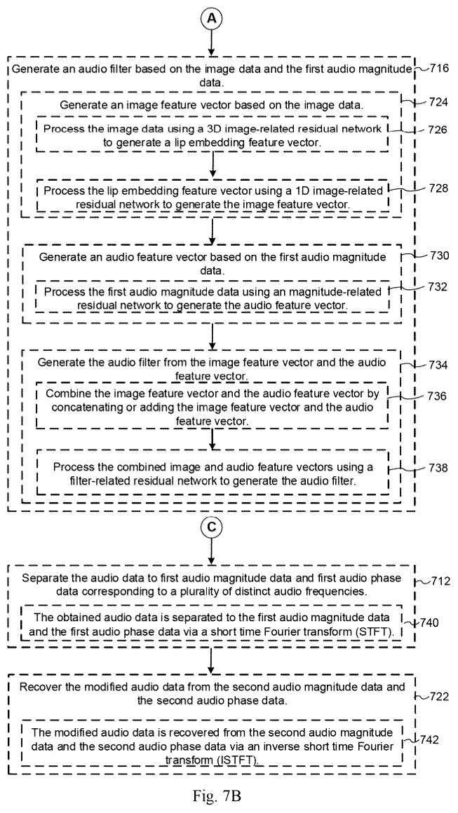

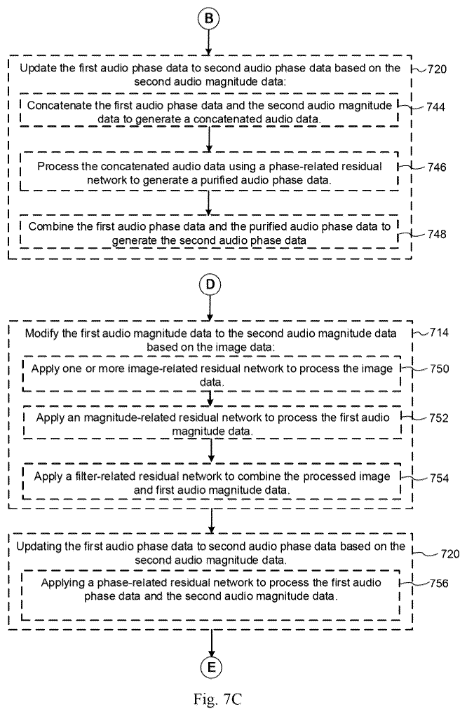

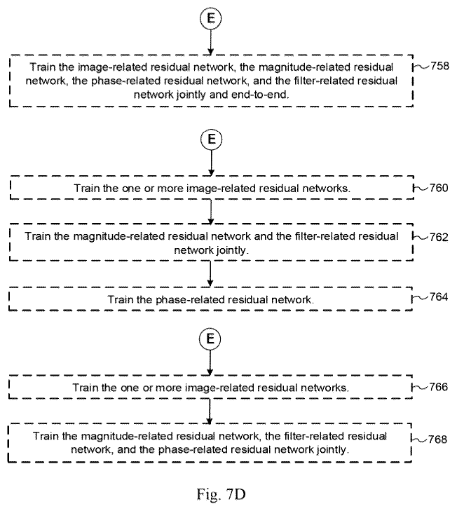

FIGS. 7A-7D are a flow diagram of an example audio purification method 700, in accordance with some embodiments. In some embodiments, the audio purification method 700 is implemented locally in an electronic device 104 (e.g. a mobile Phone), while any deep learning network applied in the method 700 is trained locally using training data downloaded from a remote server system 102. Alternatively, in some embodiments, the audio purification method 700 is implemented locally in the electronic device 104, while any deep learning network applied in the method 700 is trained remotely in the remote server system 102 and downloaded to the electronic device 104. Alternatively, in some embodiments, the audio purification method 700 is implemented in the server system 102, while any deep learning network applied in the method 700 is trained remotely in the remote server system 102 as well. Additionally and alternatively, in some embodiments, the audio purification method 700 is implemented jointly by the electronic device 104 and server system 102, i.e., split therebetween.

The method 700 includes obtaining (702) image data corresponding to a sequence of image frames (e.g., image data from the video input 502) that focus on lip movement of a person. For example, in some embodiments, the image data includes a sequence of RGB image frames, or a sequence of black and white image frame that are acquired using a camera and/or obtained from an electronic device (e.g. a mobile phone) that includes a camera.

The method 700 also includes obtaining (704) audio data (e.g., audio data from the audio input 510) that is synchronous with the lip movement in the sequence of image frames. For example, the audio data includes sound from the voice of the person as the person is speaking (and moving their lips). In some embodiments, the audio data also includes audio from other than the person, such as background noise, sounds from other people talking at the same time that the person is talking, etc.

In some embodiments, obtaining (702) image data corresponding to the sequence of image frames further includes receiving (706) raw image data corresponding to a sequence of raw image frames concerning the person. It also includes identifying (708) the image data in the raw image data, including cropping the sequence of raw image frames to the sequence of image frames that focus on the lip movement of the person.

The method 700 further includes modifying (710) the audio data using, the image data, thereby reducing background noise in the audio data.

In some embodiments, modifying (710) the audio data using the image data includes separating (712) the audio data to first audio magnitude data (e.g., audio magnitude signals 514) and first audio phase data (e.g., audio phase signals 528) corresponding to a plurality of distinct audio frequencies. Modifying (710) the audio data using the image data also includes modifying (714) the first audio magnitude data (e.g., audio magnitude signals 514) to second audio magnitude data (e.g., cleaned magnitude signals 526) based on the image data, Modifying (710) the audio data using the image data also includes updating (720) the first audio phase data (e.g., audio phase signals 528) to second audio phase data (e.g., cleaned phase signals 536) based on the second audio magnitude data. Modifying (710) the audio data using the image data further includes recovering (722) the modified audio data from the second audio magnitude data and the second audio phase data.

In some embodiments, modifying (714) the first audio magnitude data (e.g., audio magnitude signals 514) to he second audio magnitude data (e.g., cleaned magnitude signals 526) based on the image data includes generating (716) an audio filter (e.g., magnitude masks 522) based on the image data and the first audio magnitude data (e.g., output of the FC+1D Residual neural network 520). Modifying (714) the first audio magnitude data to the second audio magnitude data also includes applying (718) the audio filter (e.g., magnitude masks 522) on the first audio magnitude data (e.g., audio magnitude signals 514) to generate the second audio magnitude data (e.g., cleaned magnitude signals 526).

In some embodiments, generating (716) the audio filter based on the image data and the first audio magnitude data further includes: generating (724) an image feature vector based on the image data (e.g., image feature vectors 509); generating (730) an audio feature vector (e.g., audio feature vectors 517) based on the first audio magnitude data (e.g., audio magnitude signals 514); and generating (734) the audio filter (e.g., magnitude masks 522) from the image feature vector and the audio feature vector.

In some embodiments, generating (724) the image feature vector (e.g., image feature vectors 509) further includes: processing (726) the image data using a 3D image-related residual neural network (e.g., the lip-reading network 503) to generate a lip embedding feature vector (e.g., lip embedding feature vector generated in the lip embedding space 506); and processing (728) the lip embedding feature vector using a ID image-related. residual neural. network (e.g., ID image-related residual neural network 508) to generate the image feature vector (e.g., image feature vectors 509),

In some embodiments, generating (730) the audio feature vector (e.g., audio feature vectors 517) further includes: processing (732) the first audio magnitude data (e.g., audio magnitude signals 514) using an magnitude-related residual network (e.g., 1D audio-related residual network 516) to generate the audio feature vector (e.g., audio feature vectors 517).

In some embodiments, generating (734) the audio filter (e.g., magnitude masks 522) from the image feature vector and the audio feature vector (e.g., image feature vectors 509 and audio feature vectors 517) further includes: combining (736) the image feature vector (e.g., image feature vectors 509) and the audio feature vector (e.g., audio feature vectors 517) by concatenating or adding (e.g., concatenation or addition process 518) the image feature vector (e.g., image feature vectors 509) and the audio feature vector (e.g., audio feature vectors 517); and processing (738) the combined image and audio feature vectors (e.g., combined image and audio feature vectors 519) using a filter-related residual neural network (e.g., Fully-connected (FC)+1D residual neural network 520) to generate the audio filter.

In some embodiments, in the operation at the block 712, the obtained audio data (e.g., audio input segment 510) is separated (740) to the first audio magnitude data (e.g., audio magnitude signals 514) and the first audio phase data (e.g., audio phase signals 528) via a short time Fourier transform (STFT) STFT 512). Correspondingly, in the operation at the block 722, the modified audio data (e.g., audio output 540) is recovered (742) from the second audio magnitude data (e.g., cleaned magnitude signals 526) and the second audio phase data (e.g., cleaned phase signals 536) via an inverse short time Fourier transform (ISTFT) (e.g., ISTFT 538).

In some embodiments, updating (720) the first audio phase data to the second audio phase data based on the second audio magnitude data further includes: concatenating (744) (e.g., concatenation 530) the first audio phase data (e.g., audio phase signals 528) and the second audio magnitude data (e.g., cleaned magnitude signals 526) to generate a concatenated audio data (e.g., concatenated audio signals 531); processing (746) the concatenated audio data (e.g., concatenated audio signals 531) using a phase-related residual network (e.g., FC+1D residual neural network 532) to generate a purified audio phase data (e.g., purified phase signals 533); and combining (748) (e.g., via addition 534) the first audio Phase data (e.g., audio phase signals 528) and the purified audio phase data (e.g., purified phase signals 533) to generate the second audio phase data (e.g., cleaned phase signals 536).

In some embodiments, modifying (714) the first audio magnitude data to the second audio magnitude data based On the image data further includes applying (750) one or more image-related residual networks (e.g., the Lip-reading network 504 and/or the residual neural network 508) to process the image data. It also includes applying (752) an magnitude-related residual network (e.g., 1D audio-related residual neural network 516) to process the first audio magnitude data (e.g., audio magnitude signals 514). It also includes applying (754) a filter-related residual network (e.g., FC+1D residual neural network 520) to combine the processed image and first audio magnitude data. Updating (720) the first audio phase data (e.g., audio phase signals 528) to second audio phase data (e.g., cleaned phase signals 536) based on the second audio magnitude data (e.g., cleaned magnitude signals 526) further includes: applying (756) a phase-related residual network (e.g., FC+1D residual network 532) to process the first audio phase data (e.g., audio phase signals 528) and the second audio magnitude data (e.g., cleaned magnitude signals 526).

In some embodiments, the method 700 includes training (758) the image-related (e.g., the lip-reading network 504 and/or the ID residual neural network 508), magnitude-related (e.g., ID residual neural network 508), phase-related FC+1D residual network 532), and filter-related residual networks (e.g., .FC+1D residual neural network 520) jointly and end-to-end.

In some embodiments, the method 700 includes, in three consecutive stages: training (760) the one or more image-related residual networks; training (762) the magnitude-related and filter-related residual networks jointly; and training (764) the phase-related residual network.

In some embodiments, the method 700 includes, in two consecutive stages: training (766) the one or more image-related residual networks (e.g., the lip-reading network 504 and/or the D residual neural network 508); and training (768) the magnitude-related, filter-related, and phase-related residual networks jointly.

In some embodiments, the background noise is distinct from voice signals of the person. The obtained audio data has a signal-to-noise ratio between the voice signals of the person and the background noise. The background noise is reduced and the signal-to-noise ratio is enhanced in the modified audio data, compared with the obtained audio data.

In an example, the electronic device receives a user selection of the person with the lip movement. A plurality of persons including the person with the lip movement are identified in the sequence of original image frames. The audio data is modified to reduce voice signals of one or more persons other than the person with the lip movement.

It should be understood that the particular order in which the operations in FIGS. 7A to 7D have been described are merely exemplary and are not intended to indicate that the described order is the only order in which the operations could be performed. One of ordinary skill in the art would recognize various ways described above with reference to FIGS. 1-6 to the audio purification method 700 described in FIG. 7. For brevity, these details are not repeated here.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the embodiments described in the present application. A computer program product may include a computer-readable medium.

The terminology used in the description oldie embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, elements, and/or components, but do not preclude the presence or addition of one or more other features, elements, components, and/or groups thereof.

It will also be understood that, although the terms first, second, etc. may be used herein to describe various elements, these elements should not be limited by these terms. These terms are only used to distinguish one element from another. For example, a first network could be termed a second network, and, similarly, a second network could be termed a first network, without departing from the scope of the embodiments. The first network and the second network are both network, but they are not the same network.

The description of the present application has been presented for purposes of illustration and description, and is not intended to be exhaustive or limited to the invention in the form disclosed. Many modifications, variations, and alternative embodiments will be apparent to those of ordinary skill in the art having the benefit of the teachings presented in the foregoing, descriptions and the associated drawings. The embodiment was chosen and described in order to best explain the principles of the invention, the practical application, and to enable others skilled in the art to understand the invention for various embodiments and to best utilize the underlying principles and various embodiments with various modifications as are suited to the particular use contemplated. Therefore, it is to be understood that the scope of claims is not to be limited to the specific examples of the embodiments disclosed and that modifications and other embodiments are intended to be included within the scope of the appended claims.

What is claimed is:

1. An audio purification method, comprising:
obtaining image data corresponding to a sequence of image frames that focus on lip movement of a person;
obtaining audio data that is synchronous with the lip movement in the sequence of image frames; and
modifying the audio data using the image data, thereby reducing background noise in the audio data.

2. The method as claimed in claim 1, wherein
the obtaining the image data corresponding to the sequence of image frames that focus on lip movement of the person farther comprises:
receiving raw image data corresponding to a sequence of raw image frames concerning the person; and
identifying the image data in the raw image data, comprising cropping the sequence of raw image frames to the sequence of image frames that focus on the lip movement of the person.

3. The method as claimed in claim 1, wherein
the modifying the audio data using the image data comprises:
using lip movement data of the image data, to learn deep features of the image data and correlations of the image data with the audio data; and
using the deep features and the correlations to enhance target voice in the audio data and reducing the background noise in the audio data.

4. The method as claimed in claim 1, wherein
the modifying the audio data using the image data comprises:
separating the audio data to first audio magnitude data and first audio phase data corresponding to a plurality of distinct audio frequencies;
modifying the first audio magnitude data to second audio magnitude data based on the image data;
updating the first audio phase data to second audio phase data based on the second audio magnitude data; and recovering modified audio data from the second audio magnitude data and the second audio phase data.

5. The method as claimed in claim 4, wherein
the modifying the first audio magnitude data to the second audio magnitude data based on the image data comprises:
generating an audio filter based on the image data and the first audio magnitude data; and
applying the audio filter on the first audio magnitude data to generate the second audio magnitude data.

6. The method as claimed in claim 5, wherein
the generating the audio filter based on the image data and the first audio magnitude data further comprises:
generating an image feature vector based on the image data;
generating an audio feature vector based on the first audio magnitude data; and
generating the audio filter from the image, feature vector and the audio feature vector.

7. The method as claimed in claim 6, wherein
the generating the image feature vector based on the image data further comprises:
processing the image data using a 3D image-related residual network to generate a lip embedding feature vector; and
processing the lip embedding feature vector using a 1D image-related residual network to generate the image feature vector.

8. The method as claimed in claim 6, wherein
the generating the audio feature vector based on the first audio magnitude data further comprises:
processing the first audio magnitude data using an magnitude-related residual network to generate the audio feature vector.

9. The method as claimed in claim 6, wherein
the generating the audio filter from the image feature vector and the audio feature vector further comprises:
combining the image feature vector and the audio feature vector by concatenating or adding the image feature vector and the audio feature vector; and
processing the combined image and audio feature vectors using a filter-related residual network to generate the audio filter.

10. The method as claimed in claim 4, wherein
the separating the audio data to first audio magnitude data and first audio phase data corresponding to a plurality of distinct audio frequencies comprises:
separating the audio data to the first audio magnitude data and the first audio phase data corresponding to a plurality of distinct audio frequencies via a short time Fourier transform (STET), and
the recovering the modified audio data from the second audio magnitude data and the second audio phase data comprises:
recovering the modified audio data from the second audio magnitude data and the second audio phase data via an inverse short time Fourier transform (ISTFT).

11. The method as claimed in claim 4, wherein
the updating the first audio phase data to the second audio phase data lased on the second audio magnitude data further comprises:
concatenating the first audio phase data and the second audio magnitude data to generate a concatenated audio data;
processing the concatenated audio data using a phase-related residual network to generate a purified audio phase data; and
combining the first audio phase data and the purified audio phase data to generate the second audio phase data.

12. The method as claimed in claim 4, wherein
the modifying the first audio magnitude data to the second audio magnitude data based on the image data further comprises:
applying one or more image-related residual network to process the image data;
applying an magnitude-related residual network to process the first audio magnitude data; and
applying a lifter-related residual network to combine the processed image and first audio magnitude data; and
the updating the first audio phase data to the second audio phase data based on the second audio magnitude data further comprises:
applying a phase-related residual network to process the first audio phase data and the second audio magnitude data.

13. The method as claimed in claim 12, further comprising:
training the image-related residual network, the magnitude-related residual network, the phase-related residual network, and the filter-related residual network jointly and end-to-end.

14. The method as claimed in claim 12, further comprising, in three consecutive stages:
training the one or more image-related residual networks;
training the magnitude-related residual network and the filter-related. residual network jointly: and
training the phase-related residual network.

15. The method as claim 12, further comprising, in two consecutive stages:
training the one or more image-related residual networks; and
training the magnitude-related residual network, the filter-related residual network, and the phase-related residual network jointly.

16. The method as claimed in claim 1, further comprising:
receiving a user selection of the person with the lip movement; and
identifying in the sequence of sequence of image frames a plurality of persons including the person with the lip movement;
wherein the audio data is modified to reduce voice signals of one or more persons other than the person with the lip movement.

17. The method as claimed in claim 1, wherein:
the background noise is distinct from voice signals of the person;
the obtained audio data has a signal-to-noise ratio between the voice signals of the person and the background noise; and
the background noise is reduced and the signal-to-noise ratio is enhanced in the modified audio data, compared with the obtained audio data.

18. A computer system, comprising:
one or more processors; and
a memory having instructions stored thereon, which When executed by the one or more processors cause the processors to perform an audio purification method comprising:
obtaining image data corresponding to a sequence of image frames that focus on lip movement of a person;
obtaining audio data that is synchronous with the lip movement in the sequence of image frames; and
modifying the audio data using the image data, thereby reducing background noise in the audio data.

19. The computer system as claimed in claim 18, wherein
the obtaining the image data corresponding to the sequence of image frames that focus on lip movement of the person further comprises:
receiving raw image data corresponding to a sequence of raw image frames concerning the person; and
identifying the image data in the raw image data, comprising cropping the sequence of raw image frames to the sequence of image frames that focus on the lip movement of the person.

20. A non-transitory computer-readable medium, having instructions stored thereon, which when executed by one or more processors cause the processors to perform an audio purification method comprising:
obtaining image data corresponding to a sequence of image frames that focus on lip movement of a person;
obtaining audio data that is synchronous with the lip movement in the sequence of image frames; and
modifying the audio data using the image data, thereby reducing background noise in the audio data.
